(19) United States
(12) Patent Application Publication
(10) Pub. No.: US 2016/0305261 A1
(43) Pub. Date: Oct. 20, 2016

(54) High pressure ratio twin spool industrial gas turbine engine with dual flow high spool compressor

(71) Applicants: John A Orosa, Palm Beach Gardens, FL (US); Joseph D Brostmeyer, Jupiter, FL (US)

(72) Inventors: John A Orosa, Palm Beach Gardens, FL (US); Joseph D Brostmeyer, Jupiter, FL (US)

(21) Appl. No.: 15/092,292

(22) Filed: Apr. 6, 2016

Related U.S. Application Data
(60) Provisional application No. 62/148,423, filed on Apr. 16, 2015.

(51) Int. Cl. F01D 9/02; H02K 7/18; F01D 15/10; F01D 5/18; F02C 3/04; F02C 9/18

(52) U.S. Cl. CPC F01D 9/023; F02C 3/04; F02C 9/18; F01D 9/02; F01D 15/10; F01D 5/181; H02K 7/1823; F05D 2220/32; F05D 2220/76

(57) ABSTRACT

An industrial gas turbine engine for electrical power production includes a high pressure spool and a low pressure spool in which the low pressure spool can be operated from full power mode to zero power mode when completely shut off, where the low pressure spool is operated at high electrical demand to supply compressed air to the high pressure compressor of the high pressure spool, and where turbine exhaust is used to drive a second electric generator from steam produced in a heat recovery steam generator. The high pressure spool includes a high pressure compressor with a inner compressed air flow path and an outer compressed air flow path in which a higher pressure supplies cooling to a turbine airfoil that is then discharged into a combustor of the engine.

### CROSS-REFERENCE TO RELATED APPLICATIONS

This application claims the benefit to U.S. Provisional Application 62/148,423 filed on Apr. 16, 2015 and entitled HIGH PRESSURE RATIO TWIN SPOOL INDUSTRIAL GAS TURBINE ENGINE WITH DUAL FLOW COMPRESSOR.

### GOVERNMENT LICENSE RIGHTS

This invention was made with Government support under contract number DE-FE0023975 awarded by Department of Energy. The Government has certain rights in the invention.

### BACKGROUND OF THE INVENTION

1. Field of the Invention

The present invention relates generally to an industrial gas turbine engine, and more specifically to a twin spool industrial gas turbine engine with a low pressure spool that can be operated independently of the high pressure spool.

2. Description of the Related Art Including Information Disclosed Under 37 CFR 1.97 and 1.98

In a gas turbine engine, such as a large frame heavy-duty industrial gas turbine (IGT) engine, a hot gas stream generated in a combustor is passed through a turbine to produce mechanical work. The turbine includes one or more rows or stages of stator vanes and rotor blades that react with the hot gas stream in a progressively decreasing temperature. The efficiency of the turbine—and therefore the engine—can be increased by passing a higher temperature gas stream into the turbine. However, the turbine inlet temperature is limited to the material properties of the turbine, especially the first stage vanes and blades, and an amount of cooling capability for these first stage airfoils.

In an industrial gas turbine engine used for electrical power production, during periods of low electrical demand the engine is reduced in power. During periods of low electrical power demand, prior art power plants have a low power mode of 40% to 50% of peak load. At these low power modes, the engine efficiency is very low and thus the cost of electricity is higher than when the engine operates at full speed with the higher efficiency.

Industrial and marine gas turbine engines used today are shown in FIGS. 12-15. These designs suffer from several major issues that include low component (compressor and turbine) performance for high cycle pressure ratios or low part load component efficiencies or high CO (carbon monoxide) emissions at part load when equipped with low NOx combustors which limit the low power limit at which they are allowed to operate (referred to as the turn-down ratio).

FIG. 12 shows a single shaft IGT engine with a compressor 1 connected to a turbine 2 with a direct drive electric generator 3 on the compressor end. FIG. 13 shows a dual shaft IGT engine with a high spool shaft and a separate power turbine 4 that directly drives an electric generator 3. FIG. 14 shows a dual shaft aero derivative gas turbine engine with concentric spools in which a high pressure spool rotates around the low pressure spool, and where a separate low pressure shaft that directly drives an electric generator 3. FIG. 15 shows a three-shaft IGT engine with a low pressure spool rotating within a high pressure spool, and a separate power turbine 4 that directly drives an electric generator 3.

The configuration of FIG. 12 IGT engine is the most common for electric power generation and is limited by non-optimal shaft speeds for achieving high component efficiencies at high pressure ratios. The mass flow inlet and exit capacities are limited structurally by AN² (last stage blade stress) and tip speeds that limit inlet and exit diameters due to high tip speed induced Mach # losses in the flow. Therefore for a given rotor speed, there is a maximum inlet diameter and corresponding flow capacity for the compressor and exit diameter and flow capacity for the turbine before the compressor and turbine component efficiencies start to drop off due to high Mach # losses.

Since there is a fixed maximum inlet flow at high pressure ratios on a single shaft, the rotor blades start to get very small in the high pressure region of the compressor flow path. The small blade height at a relatively high radius gives high losses due to clearance and leakage affects. High pressure ratio aircraft engines overcome this limitation by introduction of separate high pressure and low pressure shafts. The high pressure shaft turns at a faster speed allowing for smaller radius while still accomplishing a reasonable work per stage. An example for this is shown in FIG. 14, which is typical of an aero-derivative gas turbine engine used for electrical power production. The speed of the high pressure spool is still limited by having a low speed shaft 6 inside the inner diameter (ID) of the high pressure shaft 5. This drives the high pressure shaft flow path to a higher radius relative to what might otherwise be feasible, which thereby reduces the speed of the high pressure rotor, creating smaller radius blades which reduce the efficiency of the high pressure spool. FIG. 13 arrangement is similarly limited in achieving high component efficiencies at high pressure ratios as FIG. 12 since the entire compressor is on one shaft.

Turn down ratio is the ratio of the lowest power load at which a gas turbine engine can operate (and still achieve CO emissions below the pollution limit) divided by the full 100% load power. Today's gas turbines have a turn down ratio of around 40%. Some may be able to achieve 30%. Low part load operation requires a combination of low combustor exit temperatures and low inlet mass flows. Low CO emissions require a high enough combustor temperature to complete the combustion process. Since combustion temperature must be maintained to control CO emissions, the best way to reduce power is to reduce the inlet mass flow. Typical single shaft gas turbine engines use multiple stages of compressor variable guide vanes to reduced inlet mass flow. The limit for the compressor flow reduction is around 50% for single shaft constant rotor speed compressors as in FIG. 12. The FIG. 14 arrangement is similarly limited as the FIG. 12 arrangement in inlet mass flow reduction since the low pressure compressor runs the constant speed of the generator.

The FIG. 15 arrangement is the most efficient option of the current configurations for IGT engines, but is not optimal because the low spool shaft 6 rotates within the high spool shaft 5, and thus a further reduction in the high spool radius cannot be achieved. In addition, if the speed of the low spool shaft 6 is reduced to reduce inlet mass flow, there is a mismatch of angle entering the LPT (Low Pressure Turbine) from the HPT (High Pressure Turbine) and mismatch of the flow angle exiting the LPT and entering the PT (Power Turbine) leading to inefficient turbine performance at part load.

### BRIEF SUMMARY OF THE INVENTION

An industrial gas turbine engine of the type used for electrical power production with a high pressure spool and a low pressure spool in which the two spools can be operated independently so that a turn-down ratio of as little as 12% can be achieved while still maintaining high efficiencies for the engine. An electric generator is connected directly to the high pressure spool and operates at a continuous and constant speed. The low pressure spool is driven by turbine exhaust from the high pressure spool and includes variable inlet guide vanes in order to regulate the speed of the low pressure spool. Compressed air from the low pressure spool is supplied to an inlet of the compressor of the high pressure spool. An interstage cooler can be used to decrease the temperature of the compressed air passed to the high pressure spool.

The twin spool IGT engine with separately operable spools can maintain high component efficiencies of the compressor and turbine at high pressure ratios of 40 to 55, which allow for increased turbine inlet temperatures while keeping the exhaust temperature within today's limits.

The turbine exhaust from both spools can be directed into a HRSG (heat recovery steam generator) to produce steam that is used to power a steam turbine that drives an electric generator to further increase the overall efficiency of the power plant.

In another embodiment, a fraction of the compressed air from the low pressure compressor is extracted and further compressed by a boost compressor and then delivered to a cooling circuit for the high pressure turbine stator vanes, where the heated cooling air is then discharged into the combustor.

In still another embodiment of the present invention, turbine exhaust from the high pressure spool is used to drive an intermediate pressure power turbine (IPPT) that is connected by a power shaft to an external load such as an electric generator, a gearbox, a compressor, or a ship propeller. The intermediate pressure power turbine shaft passes within the low pressure spool whereby the speed of the intermediate pressure power turbine shaft can be regulated by controlling the speed of the low pressure spool and thus regulating the mass flow amount of compressed air supplied from the low spool compressor to the high spool compressor. In this embodiment, the load is not connected to the high spool but to the intermediate pressure power turbine (IPPT).

With the design of the twin spool IGT engine of the present invention, a gas turbine combined cycle power plant can operate with a net thermal efficiency of greater than 67% which is a significant increase over current engine thermal efficiencies.

In addition, current IGT engines used for electrical power production are limited to power output of around 350 MW due to size and mass flow constraints. With the twin spool design of the present invention, existing IGT engines can be retrofitted to operate at close to double the existing maximum power output.

Another benefit of the twin spool IGT engine is that a family of different sizes of prior art single spool IGT engines can be retrofitted by including the low pressure spool design of the present invention of varying size and pressure ratio that would supply compressed air to the high spool compressor.

Cooling air used to cool hot parts of a turbine is reintroduced into a combustor in which the cooling air is discharged into a diffuser located between an outlet of the compressor and an inlet of the combustor in order to energize the boundary layer within the diffuser. In one embodiment of the diffuser, cooling air from the stator vanes is discharged parallel to the compressed air flow against an outer wall of the diffuser and cooling air from the rotor blades is discharged parallel to the compressor discharge against an inner wall of the diffuser and at a velocity equal to or greater than the velocity of the compressor discharge air so that the boundary layer in the diffuser is energized.

An Industrial Gas Turbine Engine for electrical power generator includes a high spool connected directly to an electric generator and a low spool separate from the high spool so that the two spools can be operated rotatably independently of one another. Compressed air from the low spool compressor flows into the inlet to the compressor of the high spool. The high spool compressor includes an inner flow path and an outer flow path with different temperatures of flow. The inner flow path is compressed in the high spool compressor and then discharged into the combustor. The outer flow path is first cooled in an inter-cooler and then compressed in the high spool compressor, where the cooler compressed air is then passed through stator vanes in the turbine to provide cooling. The outer flow path of the high spool compressor is about 20% of the total flow through the high spool compressor. If the outer flow compressed air is not cooled, the compressed air discharged from the high spool compressor would be too hot to be used in cooling of turbine vanes.

The high spool compressor can have the cooler air flow in the outer flow path or in the inner flow path so that the cooler compressed air can be used to cool the rotor of the high spool compressor. The high spool compressor with the dual flow paths includes rotor blades with a main blade extending from the rotor and a shroud on the end of the main blade, with one or more smaller blades extending from the shroud to form the compressor airfoils for the outer and smaller flow path.

For a proposed advanced engine cycle, about 20% of the main flow must be cooled and then compressed separately to be available as cooling flow to the turbine. The addition of a second isolated flow stream in the axial HPC compressor avoids having to add significant support systems for a separate compressor. For example, a separate axial or centrifugal compressor driven by electric motor or gear-box linked to the main gas turbine would be the current known solution.

### BRIEF DESCRIPTION OF THE SEVERAL VIEWS OF THE DRAWINGS

FIG. 1 shows a first embodiment of the gas turbine engine with turbine airfoil cooling of the present invention.

FIG. 2 shows a second embodiment of the gas turbine engine with turbine airfoil cooling with inter-stage cooling of the present invention.

FIG. 3 shows a third embodiment of the gas turbine engine with turbine airfoil cooling with inter-stage cooling of the present invention.

FIG. 4 shows a fourth embodiment of the gas turbine engine with turbine airfoil cooling with inter-stage cooling associated with a HRSG for steam production of the present invention.

FIG. 5 shows a diagram of a power plant with a first embodiment of a mechanically uncoupled twin spool industrial gas turbine engine of the present invention.

FIG. 6 shows a diagram of a power plant with a second embodiment of a mechanically uncoupled twin spool industrial gas turbine engine of the present invention.

FIG. 7 shows a diagram of a power plant with a third embodiment of a mechanically uncoupled twin spool industrial gas turbine engine of the present invention.

FIG. 8 shows a diagram of a gas turbine engine with a fourth embodiment of a mechanically uncoupled twin spool industrial gas turbine engine of the present invention.

FIG. 9 shows a cross sectional view of a power plant with a mechanically uncoupled three shaft industrial gas turbine engine of the present invention.

FIG. 10 is a cross sectional view of a diffuser used between a compressor and a combustor in the gas turbine engine of the present invention.

FIG. 11 is a cross sectional view of a second embodiment of a diffuser used between a compressor and a combustor in the gas turbine engine of the present invention.

FIG. 12 shows a prior art single shaft spool IGT engine with a direct drive electric generator on the compressor end.

FIG. 13 shows a prior art dual shaft IGT engine with a high spool shaft and a separate power turbine that directly drive an electric generator.

FIG. 14 shows a prior art dual shaft aero gas turbine engine with concentric spools in which a high spool rotates around the low spool, and where a separate low pressure shaft that directly drives an electric generator.

FIG. 15 shows a prior art three-shaft IGT engine with a low pressure spool rotating within a high pressure spool, and a separate power turbine that directly drives an electric generator.

FIG. 16 shows a cross section view of a prior art twin spool aero gas turbine engine with a high spool concentric with and rotatable around the low spool.

FIG. 17 shows a cross section view of a mechanically uncoupled twin spool industrial gas turbine engine of the present invention.

FIG. 18 shows a diagram of a power plant with a mechanically uncoupled twin spool industrial gas turbine engine having a dual flow compressor for another embodiment of the present invention.

FIG. 19 shows a cross section view of the dual flow compressor with the smaller flow on the outer flow path of the present invention.

FIG. 20 shows a cross section view of the dual flow compressor of FIG. 19 with a second dual flow compressor located downstream of the present invention.

FIG. 21 shows a cross section view of a dual flow compressor with the smaller flow on the inner flow path with additional blades to further compress the inner flow path of the present invention.

FIG. 22 shows a view of one of the blades in the dual flow compressor of the present invention with multiple blades in the outer flow path with one blade on the inner flow path separated by a shroud.

FIG. 23 shows a view of one of the blades in the dual flow compressor of the present invention with multiple blades in the inner flow path and one blade extending from the shroud in the outer flow path.

### DETAILED DESCRIPTION OF THE INVENTION

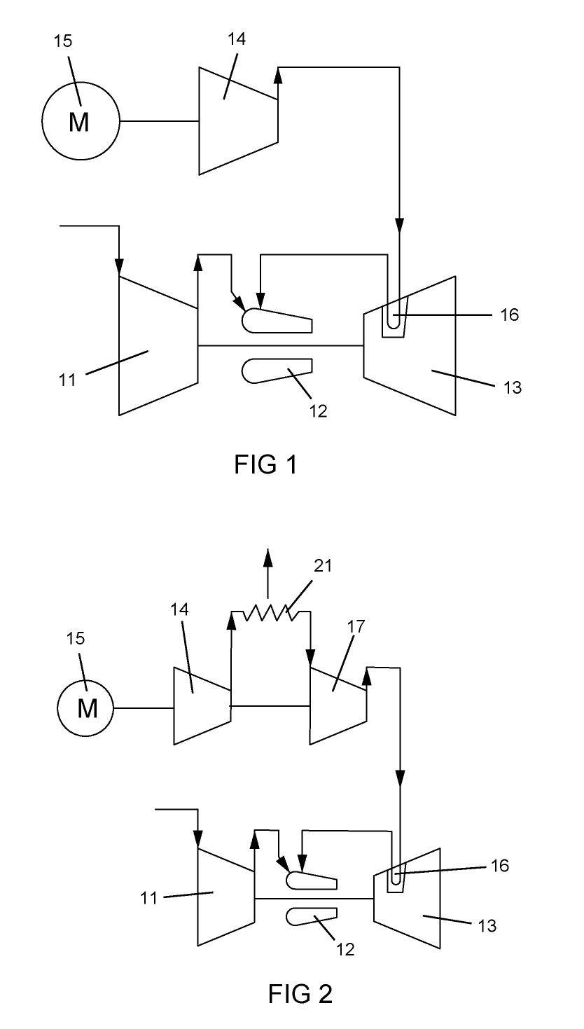

The present invention is a gas turbine engine with cooling of the turbine stator vanes. FIG. 1 shows a first embodiment of the present invention with a gas turbine engine having a main compressor 11, a combustor 12 and a turbine 13 in which the compressor 11 and the turbine 13 are connected together by a rotor shaft. The turbine 13 has a first stage of stator vanes 16 that are cooled. The compressor 11 compresses air that is then burned with a fuel in the combustor 12 to produce a hot gas stream that is passed through the turbine 13. A second or cooling air compressor 14 is driven by a motor 15 to compress air at a higher pressure than from the first compressor 11. The higher compressed air is then passed through the stator vanes 16 in the turbine 13 for cooling, and the heated cooling air is then passed into the combustor 12 to be combined with the fuel and the compressed air from the first or main compressor 11.

The second or cooling air compressor 14 produces high pressure compressed air for cooling of the stator vanes 16 such that it can then be discharged into the combustor 12. Without the suitable higher pressure from the cooling air compressor 14, the cooling air pressure discharged from the stator vanes would not be high enough pressure to pass into the combustor 12.

FIG. 2 shows a second embodiment of the present invention in which a cooling air flow compression system includes a low pressure compressor (LPC) 14 and a high pressure compressor (HPC) 17 with an intercooler 21 in-between to cool the compressed air from the LPC. The compressed air from the cooling air flow compression system (14, 17) and the intercooler 21 is then used to cool the stator vanes 16 which is then discharged into the combustor 12. The cooling air flow compression system (14, 17) with the intercooler 21 produces a higher pressure cooling air than the first compressor 11 so that enough pressure remains after cooling of the stator vanes 16 to be discharged into the combustor 12.

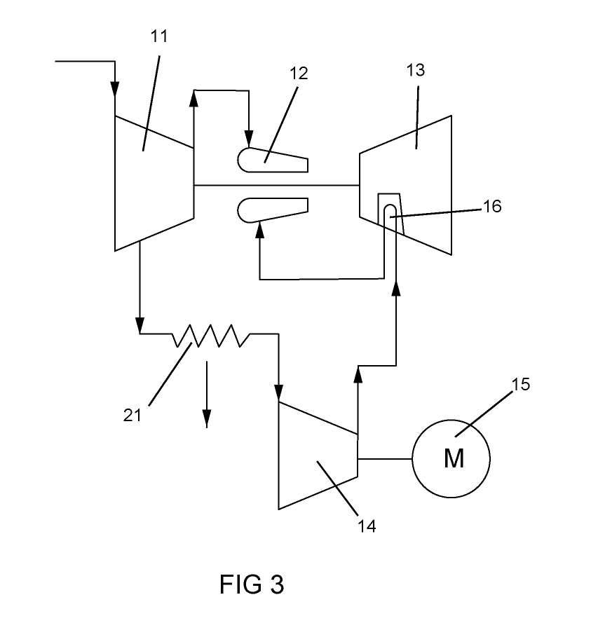

FIG. 3 shows a third embodiment of the present invention where the cooling air for the stator vanes 16 is bled off from a later stage (after the first stage) of the main flow compressor 11, passed through an intercooler 21, and then enters a cooling air compressor 14 to be increased in pressure. The higher pressure air from the cooling air compressor 14 is then passed through the stator vanes 16 for cooling, and then discharged into the combustor 12.

In the three embodiments, the first or main flow compressor 11 provides approximately around 80% of the required air for the combustor 12. The second or cooling air compressor 14 produces the remaining 20% for the combustor 12. In one industrial gas turbine engine studied, the first or main flow compressor 11 has a pressure ratio of 30 while the second or cooling air compressor 14 has a pressure ratio of 40.

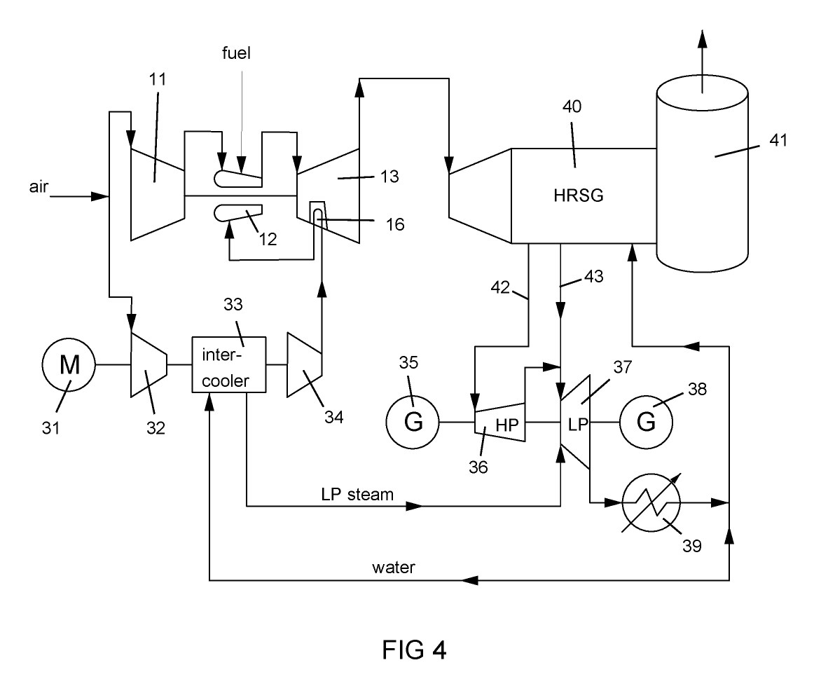

FIG. 4 shows another embodiment of the present invention with turbine cooling and an intercooler heat recovery. The gas turbine engine includes a main flow compressor 11, a combustor 12, and a turbine 13 in which a turbine airfoil such as a stator vane 16 is cooled. Fuel is introduced into the combustor 12 to produce a hot gas stream that is passed through the turbine 13. Compression of the turbine cooling air flow takes place in low pressure compressor 32 and a high pressure compressor 34 with an intercooler 33 in-between. An intercooler/low pressure steam generator 33 is positioned between high and low pressure compressors 32 and 34 to cool the compressed air so that it is more effective in cooling turbine airfoil 16. A motor 31 drives both compressors 32 and 34 that compress air for use in cooling of the turbine airfoil 16.

The gas turbine 13 exhaust is used to produce steam in a Heat Recovery Steam Generator (HRSG) 40. The HRSG 40 produces high pressure (HP) steam 42 that is delivered to a high pressure turbine 36 to drive a first electric generator 35. The HRSG 40 also produces low pressure (LP) steam 43 that is combined with LP steam from the HP turbine exhaust that flows into a low pressure (LP) turbine 37 that drives a second electric generator 38. A stack 41 discharges the turbine exhaust after use in the HRSG 40. A condenser 39 condenses the steam discharged from the LP turbine 37 into water that then flows into the HRSG 40 or to the intercooler 33. Water that flows into the intercooler 33 is used to cool the compressed air discharged from the low pressure compressor 32 producing low pressure (LP) steam that then flows into the inlet of the LP turbine 37 along with the LP steam from the HRSG 40. As a result, the compressed air from the high pressure compressor 34 has a lower temperature than without the use of an intercooler and therefore the cooling of the turbine airfoil 16 is improved. The cooling air from the turbine airfoil 16 is then discharged into the combustor 12 to be burned with fuel and produce the hot gas stream for the turbine 13.

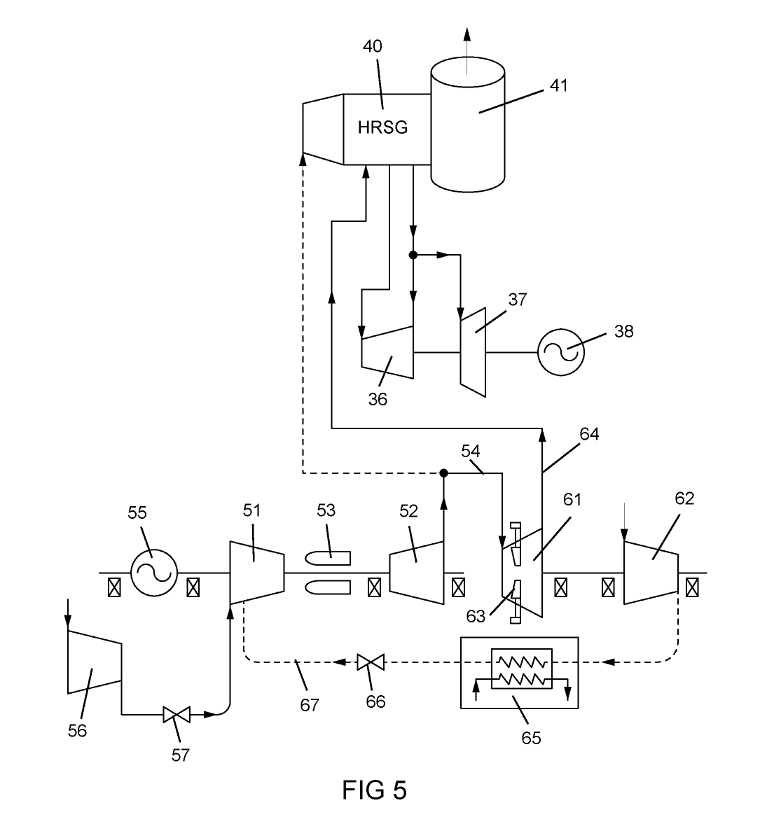

The embodiment of FIG. 5 is a high pressure ratio flexible industrial gas turbine engine with non-concentric spools in which the high pressure spool can be operated together or without the low pressure spool depending on the electrical power load. FIG. 5 shows the power plant to include a main gas turbine engine with a high pressure compressor 51, a combustor 53, and a high pressure gas turbine 52 connected by a rotor shaft to an electric generator 55. The main engine (51, 52, 53) and the generator 55 are rotatably supported by bearings. In an option for supply the inlet air to the high pressure compressor 51, the inlet of the main high pressure compressor 51 is connected to a boost compressor 56 through a valve 57. The high pressure compressor 51 and the high pressure turbine 52 are part of the high pressure spool.

A low pressure gas turbine 61 is connected to a low pressure compressor 62 by a rotor shaft which is supported by bearings. The low pressure compressor 62 includes an inlet guide vane and variable stator vanes 63 allowing for modulating the compressed air flow. The low pressure gas turbine 61 and low pressure compressor 62 forms a low pressure spool and is non-concentric (can operate independently) with the main engine or high pressure spool 51 and 52. Similarly, the high pressure compressor can also include variable stator vanes that allow for flow matching and speed control. Thus, the low pressure spool 61 and 62 can be shut down and not be operated while the main engine or high speed spool 51 and 52 operates to drive the electric generator 55. An outlet of the low pressure compressor 62 is connected by a line 67 to an inlet of the high pressure compressor 51. An intercooler 65 can be used between the outlet of the low pressure compressor 62 and the inlet of the high pressure compressor 51 to cool the compressed air. A valve 66 can also be used in the line 67 for the compressed air from the low pressure compressor 62 to the high pressure compressor 51. FIG. 5 shows the dashed inlet to the high pressure compressor 51 at a later stage, but could be located upstream from the first stage compressor blades.

Major advantages of the twin spool turbo-charged industrial gas turbine engine of the present invention (with one embodiment shown in FIG. 5) are described here. A large frame heavy duty industrial gas turbine engine of the prior art uses only a single spool with the rotor shaft directly connected to an electric generator. This design permits a large amount of power transfer to the generator without the need for a gearbox. Due to these factors, the gas turbine must operate with a very specific rotor speed equal to the synchronization speed of the local electrical power grid. By separating the components of the gas turbine into modular systems, each can then be individually optimized to provide maximum performance within an integrated system. Also, substantial power output and operability improvements can be realized.

The efficiency of the gas turbine is known to be largely a function of the overall pressure ratio. While existing IGTs limit the maximum compressor pressure ratio that can be achieved because optimum efficiency cannot be achieved simultaneously in the low and high pressure regions of the compressor while both are operating at the same (synchronous) speed, an arrangement that allows the low and high pressure compressors to each operate at their own optimum rotor speeds will permit the current overall pressure ratio barrier to be broken. In addition, segregating the low and high pressure systems is enabling for improve component efficiency and performance matching. For example, the clearance between rotating blade tips and outer static shrouds or ring segments of existing IGTs must be relatively large because of the size of the components in the low pressure system. In the present invention, the clearances in the high pressure system could be reduced to increase efficiency and performance.

The twin spool turbocharged IGT of the present invention enables a more operable system such that the engine can deliver higher efficiency at turn-down, or part power, and responsiveness of the engine can be improved. Further, this design allows for a greater level of turndown than is otherwise available from the prior art IGTs.

In yet another example, the power output and mass flow of prior art IGTs is limited by the feasible size of the last stage turbine blade. The length of the last stage turbine blade is stress-limited by the product of its swept area (A) and the square of the rotor speed (N). This is commonly referred to as the turbine AN². For a given rotor speed, the turbine flow rate will be limited by the swept area of the blade. If the rotor speed could be reduced, the annulus area could be increased, and the turbine can then be designed to pass more flow and produce more power. This is the essence of why gas turbines designed for the 50 Hz electricity market, which turn at 3,000 rpm, can be designed with a maximum power output capability which is about 44% greater than an equivalent gas turbine designed for the 60 Hz market (which turns at 3,600 rpm). If the gas turbine engine could be designed with modular components, a separate low pressure system comprising a low pressure compressor and turbine could be designed to operate at lower speeds to permit significantly larger quantities of air to be delivered to the high pressure (core) of the gas turbine.

In prior art IGTs, size and speed, AN², and limits on the past stage turbine blade eventually lead to efficiency drop-off as pressure ratio and turbine inlet temperatures are increased. In addition, as pressure ratio increases, compressor efficiency begins to fall off due to reduction in size of the back end of the compressor which leads to higher losses. At higher pressure ratios, very small airfoil heights relative to the radius from the engine centerline are required. This leads to high airfoil tip clearance and secondary flow leakage losses. The twin spool turbocharged IGT of the present invention solves these prior art IGT issues by increasing the flow size of a prior art large IGT up to a factor of 2. Normally, this flow size increase would be impossible due to turbine AN² limits. The solution of the present invention is to switch from single spool to double spool which allows for the last stage turbine blade to be designed at a lower RPM which keeps the turbine within typical limits. A conventional design of a dual spool engine would place the electric generator on the low spool, fixing the speed of the electric generator, and have a higher RPM high spool engine. With the twin spool turbocharged IGT of the present invention, the electric generator is located on the high spool, and has a variable speed low spool. This design provides numerous advantages. Since the low spool is untied from the grid frequency, a lower RPM than synchronous can be selected allowing the LPT to operate within AN² limits. Another major advantage is that the low spool RPM can be lowered significantly during operation which allows for a much greater reduction of engine air flow and power output than can be realized on a machine with a fixed low spool speed. The twin spool turbocharged IGT of the present invention maintains a higher combustion discharge temperature at 12% load than the prior art single spool IGT operating at 40% load. In the twin spool turbocharged IGT of the present invention; power was reduced by closing the inlet guide vanes on the high pressure compressor. Low and high pressure compressor aerodynamic matching was accomplished using a variable LPT vane which reduces flow area into the LPT, thus reducing low spool RPM.

A prior art single spool IGT is capable of achieving a low power setting of approximately 40-50% of max power. The twin spool turbocharged IGT of the present invention is capable of achieving a low power setting of around 12% of max power. This enhanced turndown capability provides a major competitive advantage given the requirements of flexibility being imposed on the electrical grid from variable power generation sources.

In FIG. 5, a HRSG (Heat Recovery Steam Generator) 40 with stack 41 is used to take the exhaust gas from the gas turbines 52 and 61 through line 64 and produce steam for use in high pressure steam turbine 36 and low pressure steam turbine 37 that are both connected to drive a second electric generator 38. The exhaust finally is discharged through a stack 41. The dash line in FIG. 5 represents a direct connection from the exhaust of the high pressure gas turbine to the HRSG 40 which would bypass the low pressure gas turbine 61.

During periods of high electrical power demand, the main engine with the high pressure compressor 51 and high pressure gas turbine 52 is operated to drive the electric generator 55 with the gas turbine 52 exhaust going into the power or low pressure gas turbine 61 to drive the low pressure compressor 62. The exhaust from the low pressure gas turbine 61 then flows into the HRSG 40 to produce steam to drive the two steam turbines 36 and 37 that drive the second electric generator 38. The low pressure compressed air from the low pressure compressor 62 flows into the inlet of the high pressure compressor 51.

During periods of low electrical power demand, the low pressure gas turbine 61 and the low pressure compressor 62 is operated at low speed and the exhaust from the high pressure gas turbine 52 flows into the HRSG 40 through the low pressure gas turbine 61 and line 64 to produce steam for the two steam turbines 36 and 37 that drive the second electric generator 38 and thus keep the parts of the HRSG hot for easy restart when the engine operates at higher loads. Flow into the high pressure compressor 51 is reduced to 25% of the maximum flow. Thus, the main engine (51, 52, 53) can go into a very low power mode. The prior art power plants have a low power mode of 40% to 50% (with inlet guide vanes in the compressor) of peak load. The present invention can go down to 25% of peak load while keeping the steam temperature temporarily high of the power plant hot (by passing the hot gas flow through) for easy restart when higher power output is required. The inter-cooler 65 can also include water injection to cool the low pressure compressed air.

At part power conditions between full power and the lowest power demand, it may be necessary to operate the low pressure compressor 62 and low pressure turbine 61 at an intermediate rotor speed. A means for controlling the engine is necessary in order to reduce low spool rotor speed without shutting off completely, while ensuring stable operation of the low pressure compressor 62 and high pressure compressor 51. Without a safe control strategy, part power aerodynamic mismatching of the compressor can lead to compressor stall and/or surge, which is to be avoided for safety and durability concerns. A convenient way to control the low rotor speed while correctly matching the compressors aerodynamically is by means of a variable low pressure turbine vane 63. Closing the variable low pressure turbine vane 63 at part power conditions reduces the flow area and flow capacity of the low pressure turbine 61, which subsequently results in a reduction of low pressure spool (61, 62) rotational speed. This reduction in rotor speed reduces the air flow through the low pressure compressor 62 which provides a better aerodynamic match with the high pressure compressor 51 at part power.

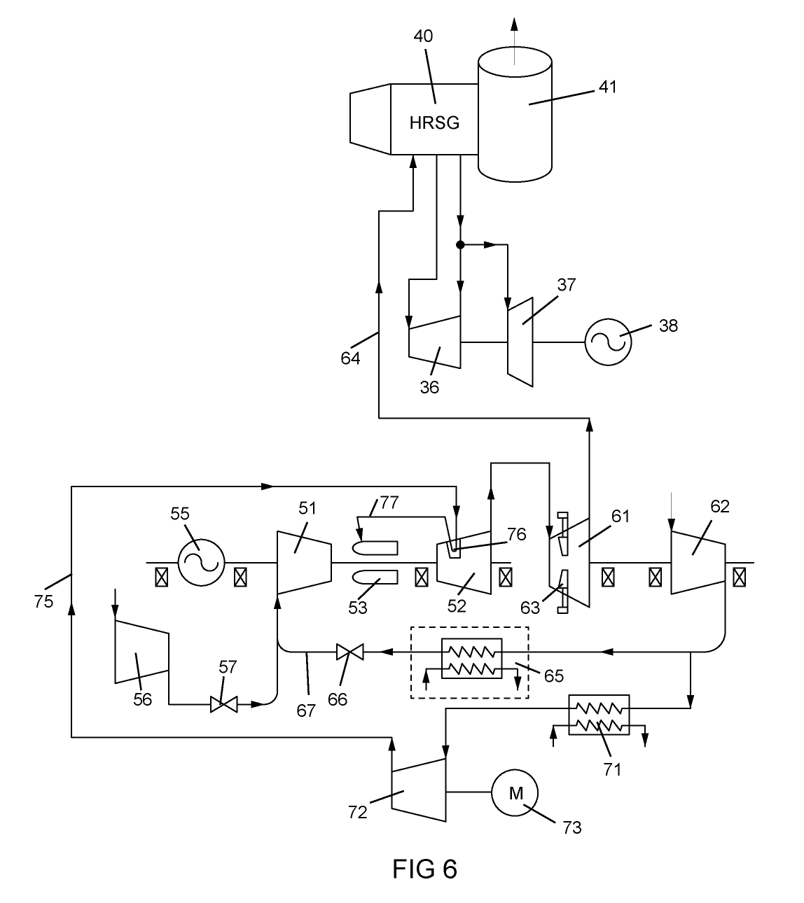

The embodiment of FIG. 6 is similar to that in FIG. 5 but with the addition of cooling air used for the high pressure turbine 52 stator vanes 76 that are then discharged into the combustor 53 of the high spool. To increase an overall efficiency of the electrical energy producing power plant of the present invention (FIG. 6), some of the compressed air discharged from the low pressure compressor 62 can be passed through an intercooler 71, through a cooling air compressor 72 driven by a motor 73, through line 75 and then used to cool the stator vanes 76 in the high pressure gas turbine 52 of the high speed spool. This cooling air is then passed through line 77 and is discharged into the inlet of the combustor 53 and combined with the compressed air from the high pressure compressor 51 for combustion with a fuel to produce the hot gas flow used to drive the two gas turbines 52 and 61. The amount of compression produced by the cooling air compressor 72 is sufficient to overcome the pressure losses from cooling the stator vanes 76 and to maintain sufficient over-pressure to flow into the combustor 53. The LPC 62 flow not passed to the intercooler 71 is passed through an optional intercooler 65 along the path to the high pressure compressor 51 inlet.

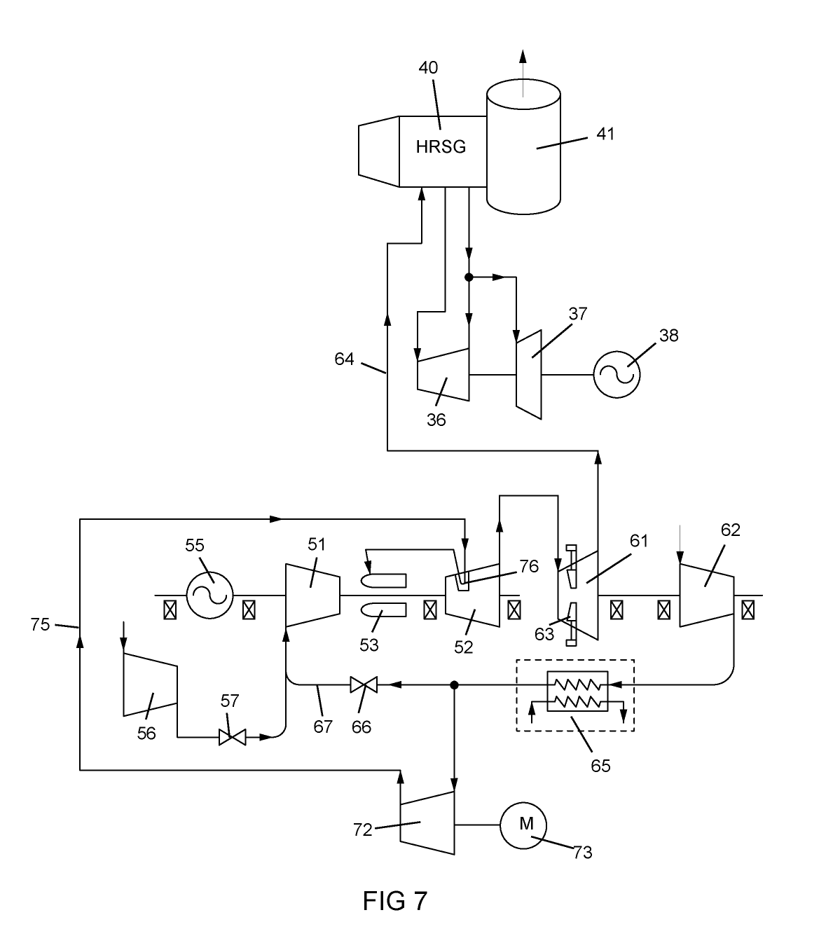

The embodiment of FIG. 7 is similar to the embodiment in FIG. 6 but with only one intercooler 65 used to cool the compressed air going into the high pressure compressor 51 and the stator vanes 76 of the high pressure turbine 52. A cooling air compressor 72 driven by a motor 73 is used to increase the pressure of the low pressure compressor 62 high enough to pass through the stator vanes 76 with enough pressure to flow into the combustor 53 at around the same pressure as the high pressure compressor outlet for discharged into the combustor 53.

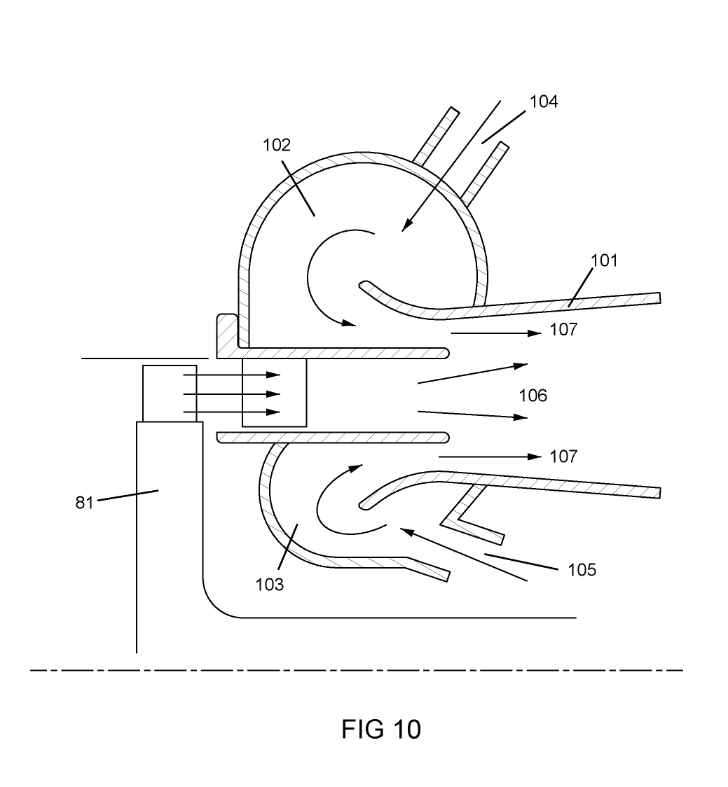

In the gas turbine engine embodiment of FIGS. 6 and 7, the compressed air used to cool the stator vanes in the high pressure turbine is injected into the combustor 53. In a further embodiment of the present invention, a diffuser 101 is positioned between an outlet of the high pressure compressor 51 and an inlet of the combustor 53 that diffuses the compressed air flow. To control a boundary layer flow of the diffused air flow, the cooling air from the stator vanes 104 and from the rotor blades 105 of the high pressure turbine 52 is discharged into the diffuser 101 to merge with the compressed air from the high pressure compressor 81 prior to entering the combustor 53. In the FIG. 10 embodiment, the cooling air from the stator vanes 76 is discharged into an outer plenum 102 surrounding the diffuser 101 that directs the cooling air flow in a direction parallel to the discharged compressed air 106 from the compressor 81. In a similar method, the cooling air from the rotor blades is discharged into an inner plenum 103 where the cooling air flows parallel to the discharged compressed air 106 from the compressor. The cooling air from the two plenums 102 and 103 is accelerated to a velocity equal to or greater than the velocity of the compressed air 106 from the compressor in order to prevent the boundary layer from forming.

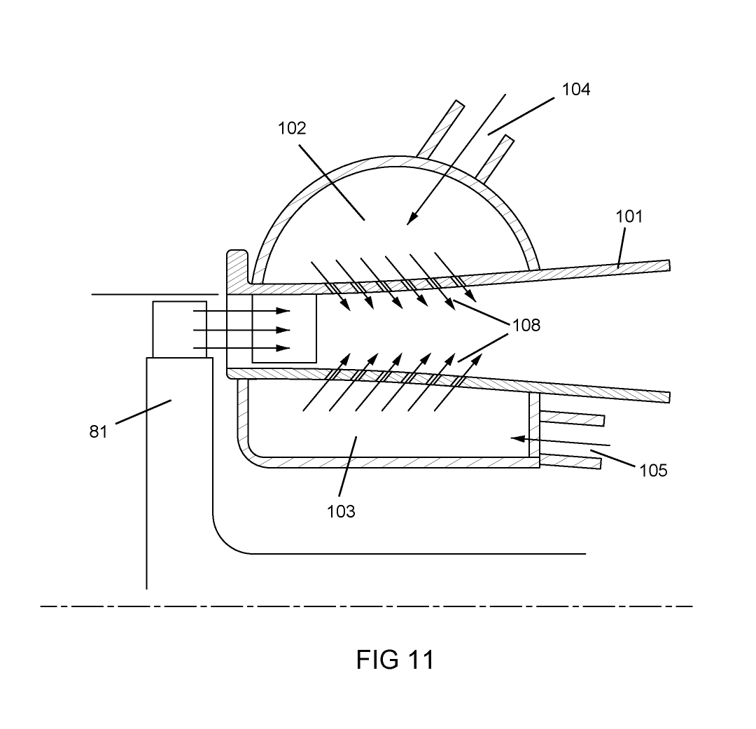

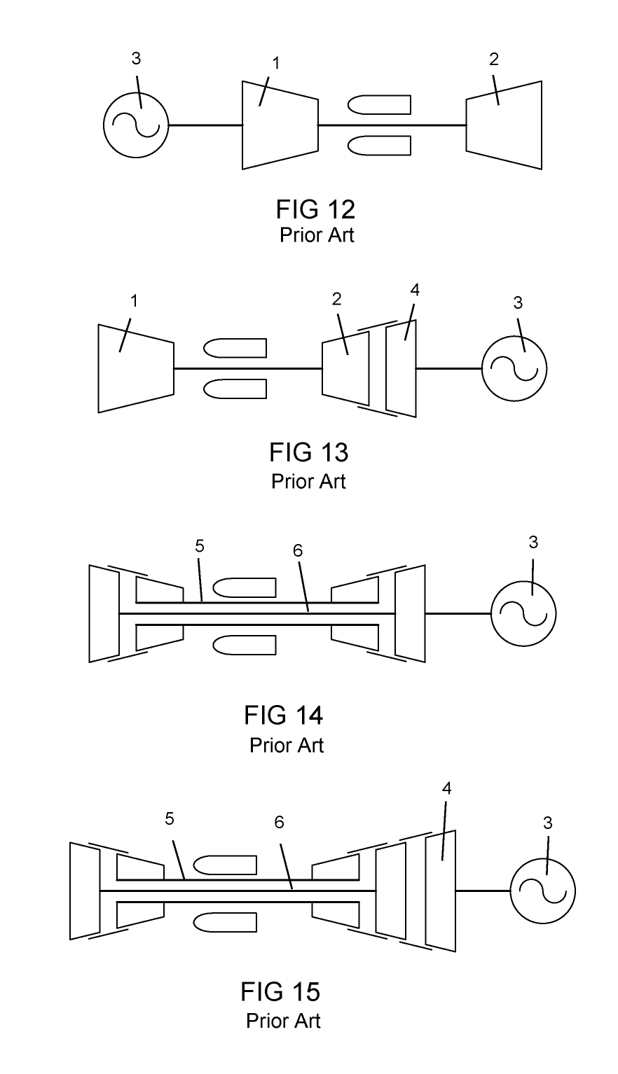

FIG. 11 shows a second embodiment of the diffuser 101 in which the cooling air flow from the stator vanes and the rotor blades is discharged into the diffuser 101 from the two plenums 102 and 103 through an arrangement of film cooling holes 108.

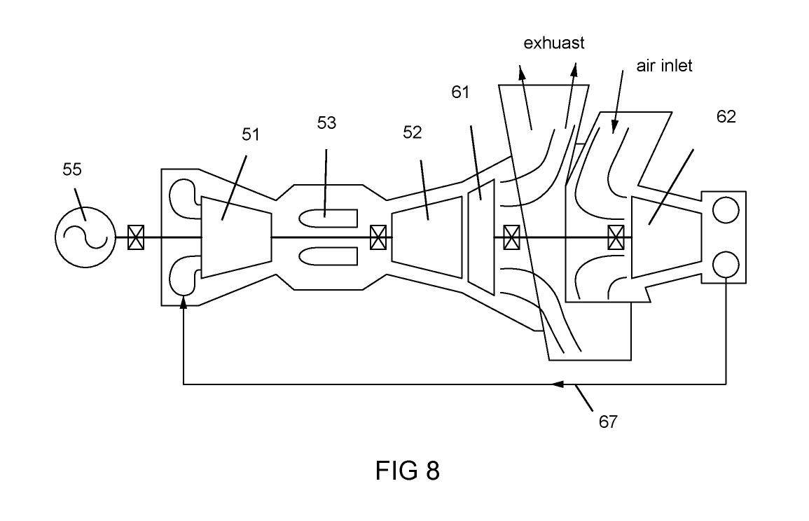

FIG. 8 shows a cross sectional arrangement of a twin spool turbo-charged IGT for the present invention. The low pressure turbine 61 with variable area nozzle is located within a flow case just behind the exit from the high pressure turbine 52 so that the flow from the high pressure turbine flows directly into the low pressure turbine without loss. The rotor shaft from the LPT 61 to the LPC 62 passes through the case that forms the exhaust for the turbine hot gas and the inlet for the air into the LPC 62. The LPC 62 is connected by the line 67 to an inlet of the HPC 51. The high spool (with HPC 51 and HPT 52) directly drives an electric generator 55.

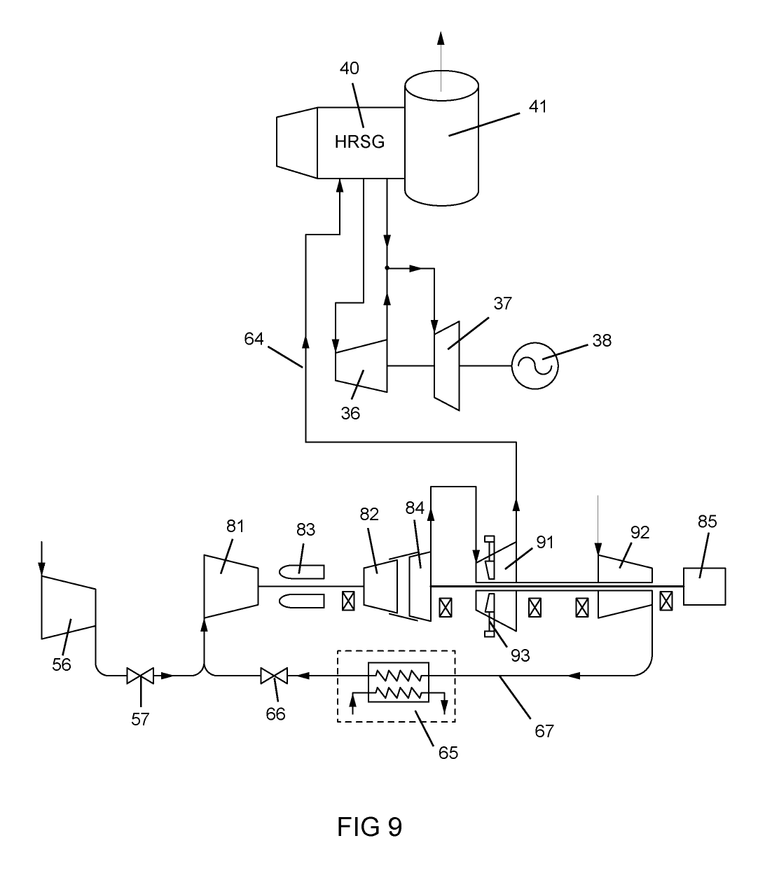

FIG. 9 shows an embodiment of the present invention in which the power plant can be used to drive a load 85 where the load can be an electric generator or a compressor or a screw propeller for a ship. The power plant in FIG. 9 includes the high spool and the low spool like in previous embodiments, but with an intermediate pressure power turbine (IPPT) that is driven by exhaust from the HPT to drive the load 85 through a free shaft (FS). A high pressure compressor 81 is rotatably connected to a high pressure turbine 82 through a rotor with a combustor 83 located in-between to form the high spool. A low pressure turbine 91 is rotatably connected to a low pressure compressor 92 to form the low spool. The LPT includes variable inlet guide vanes or nozzles 93. The high pressure compressor 81 also has multiple variable stator vanes (VSV). An intermediate pressure power turbine (IPPT) 84 is located immediately downstream from the HPT 82 and is rotatably connected to the load 85 through a free shaft (FS) that passes through the inside of the rotor shaft of the low spool. A compressed air line 67 connects the outlet of the LPC 92 to an inlet of the HPC 81, and can include an intercooler 65. A boost compressor 56 can be used to supply low pressure compressed air to the HPC 81 when the low spool (91, 92) is running low. An optional HRSG 40 is connected to the LPT 91 exhaust to convert the turbine exhaust into steam and drive the high pressure steam turbine 36 and the low pressure steam turbine 37 that both drive the electric generator 38. The power turbine 84 and the HPT 82 are located within a case close to one another as are the LPT 61 and HPT 52 in FIG. 8. The HRSG might not be needed if the engine is used to propel a ship.

The twin spool IGT engine of FIG. 9 shows another novel arrangement which has many of the same attributes of FIGS. 5-7 embodiments. However, the mechanical or generator load speed is allowed to operate independent of the gas turbine high pressure shaft speed via a low pressure shaft connected to the load. This independent load shaft speed attribute is usually most important for mechanical loads. The FS (free shaft) is still free to slow down for improved part load performance and low turndown to 12% load. Note, the low pressure shaft is passed through the (ID) of the FS since the FS runs at low speed and higher radius compared to the HP shaft. Thus, the HP shaft speed can remain high in this arrangement.

Options for the FIG. 9 power plant include; intercool the entire flow from the LPC 92 to the HPC 81; intercool only the compressed air that is used to cool the stator vanes in the HPT 82; and intercool only the cooling air used for the cooling of the stator vanes and over-pressurize the cooling air with a separate boost compressor. In all of the arrangements, a variable geometry HPC 81 is used to control speed along with the variable LPT vane 93.

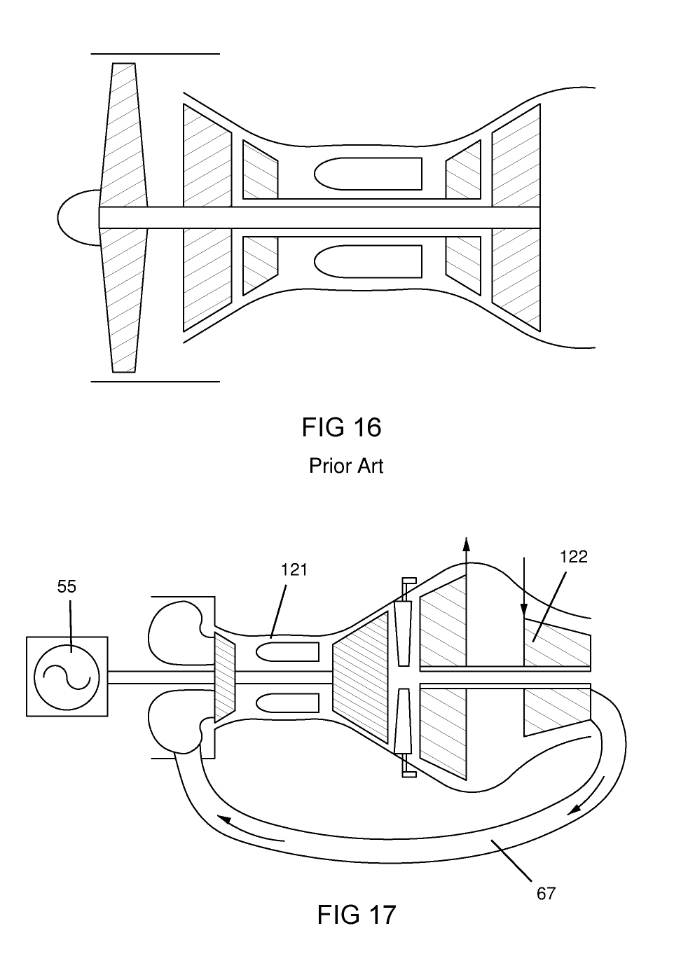

FIG. 17 shows a twin spool turbo-charged IGT of the present invention that does not require an intercooler 65 for cooling the compressed air that is delivered to the stator vanes of the turbine like in the FIG. 9 embodiment. The power turbine can be operated rotational independently of the main core engine 121 that drives the electric generator 55 as opposed to the prior art twin spool aero engine shown in FIG. 16. The high pressure spool and the low pressure spool operate together (FIG. 16 aero engine) because the hot gas stream from the compressor must flow through both turbines so that both compressors are driven. In the twin spool turbo-charged IGT of the present invention, the low pressure spool 122 can operate at different speeds while the main core engine 121 (the high spool that drives the electric generator 55) can operate at a constant speed.

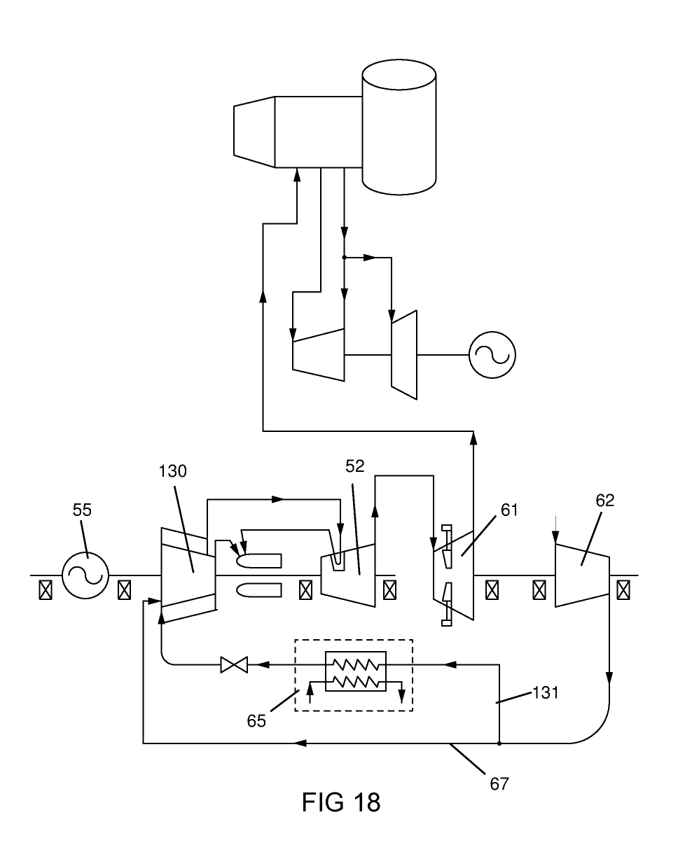

FIG. 18 shows an illustration of an embodiment of the power plant of the present invention in which the dual flow compressor is used. The high pressure turbine 52 of the main engine drives the dual flow compressor 130 that has an inner flow path separated from but concentric with an outer flow path, where the inner flow path flows into the combustor while the outer flow path flows into the stator vanes for cooling thereof. The compressed air from the low spool compressor 62 is split up into a main flow 67 that flows into the inner flow path of the compressor 130 and a smaller flow 131 (around 20%) that flows through an inter-cooler 65 to provide cooling. This smaller and cooled compressed air flow then flows into the outer flow path of compressor 130 and then to one or more rows of the stator vanes of the turbine 52 to provide cooling of the stator vanes. The cooling air is then discharged into the combustor. The cooling air from the low spool compressor 62 used for cooling of the stator vanes must be compressed further and cooled in order to adequately cool the stator vanes and have enough pressure to pass through the stator vanes and then flow into the combustor. With the dual flow compressor, a separate compressor is not needed to further compress the air from the low spool compressor that is used for cooling the stator vanes.

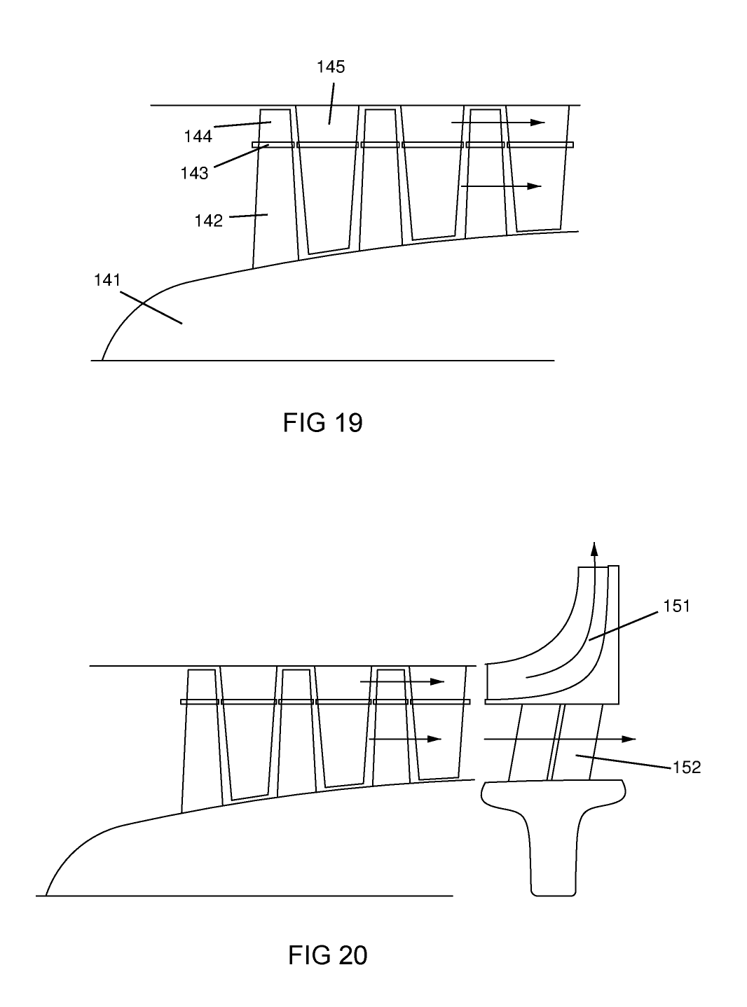

FIG. 19 shows one embodiment of the dual flow compressor of the present invention. Rotor blades extend from the rotor 141 with stator vanes 145 extend from the stator or casing. Each rotor blade includes an inner airfoil 142 and an outer airfoil 144 with a shroud 143 separating the two flow paths formed by the inner and outer airfoils. Each stator vane 145 also includes a shroud to separate the inner air flow path from the outer air flow path. A number of stages of blades and vanes are used to compress the air to the desired pressure.

In FIG. 20, a second compressor is used to further compress the air. The rotor includes a first rotor blade 152 on the inner flow path and a second compressor blade 151 on the outer flow path. The second compressor blade 151 in this embodiment is a centrifugal compressor that can increase the pressure of the outer flow path beyond the pressure in the inner flow path so that turbine stator vane cooling can be performed with enough remaining pressure to dump the cooling air from the stator vanes back into the combustor. The first and second compressors are connected to the same rotor and thus rotate together. Because around 20% of the total compressed air flow is used for cooling of the stator vanes in the turbine, the outer flow path in the FIGS. 19 and 20 embodiments are smaller such that 20% of the total flow through the compressor flow in the outer flow path.

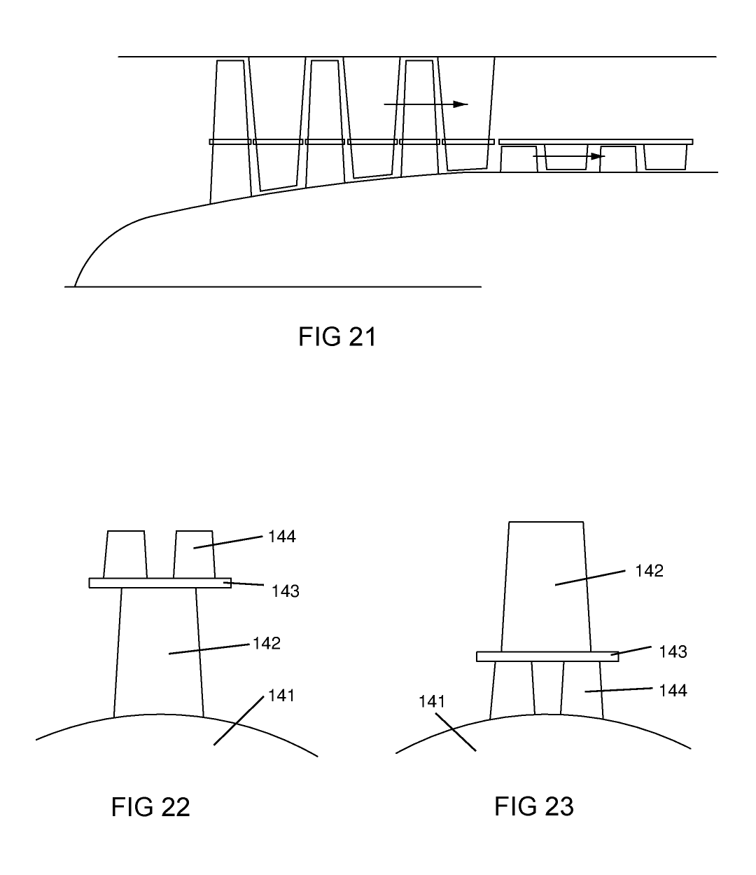

FIG. 21 shows a second embodiment of the dual flow compressor of the present invention where the smaller flow path of the 20% flows along the inner flow path. Passing the smaller air flow along the inner flow path provides cooling of the rotor. In the FIG. 21 embodiment, the inner flow path extends further aft with rotor blades and stator vanes than the outer flow path because the inner flow path must be at a higher pressure than the outer flow path since the cooling air from the inner flow path is used for cooling of the turbine stator vanes.

FIG. 22 shows an embodiment of rotor blades used in the dual flow compressor where one large blade 142 extends from the rotor 141 with a number of smaller blades 144 extending from the shroud 143. Because the outer flow path is smaller, more blades can be used for each stage to compress the air. This blade would be used in the dual flow compressor of FIGS. 19 and 20.

FIG. 23 shows an embodiment of the blades used in the dual flow compressor of FIG. 21 where the smaller blades 144 are in the inner flow path and the larger blade 142 are in the outer flow path. The shroud 143 separates the two flow paths. Multiple blades 144 can used in the smaller flow path to keep passage aspect ratios from getting too small. One or more blades 144 can be used. The FIG. 23 embodiment suffers from the issue that the smaller blades 144 must support the large blade 142 located radially outward. If the smaller inner blades can structurally support the larger outer blade, then this embodiment would allow for the compressed air used for cooling the stator vanes to flow along the rotor for additional cooling of the rotor. In the FIG. 23 embodiment, one or more blades 144 can be used.

We claim the following:

1. An industrial gas turbine engine for electrical power production, the industrial gas turbine engine comprising:
a high pressure spool with a high pressure compressor and a high pressure turbine;
a electric generator connected to the high pressure spool to produce electrical power;
a low pressure spool with a low pressure compressor and a low pressure turbine;
the high pressure spool and the low pressure spool being capable of rotating independently;
an outlet of the low pressure compressor of the low pressure spool being connected to an inlet of the high pressure compressor of the high pressure spool;
the high pressure compressor having a first flow path to supply compressed air at a first pressure to a combustor;
the high pressure compressor having a second flow path concentric with the first flow path to supply compressed air at a second pressure higher than the first pressure to an air cooled airfoil within the high pressure turbine; and,
cooling air from the air cooled airfoil is discharged into the combustor.

2. The industrial gas turbine engine of claim 1, and further comprising:
the high pressure compressor includes multiple rows of rotor blades and stator vanes in which each airfoil includes a shroud separating an inner compressed air flow path from an outer compressed air flow path.

3. The industrial gas turbine engine of claim 1, and further comprising:
the high pressure compressor includes a second compressor downstream from a first compressor; and,
the second compressor includes an inner axial compressor and an outer centrifugal compressor both connected to a common rotor.

4. The industrial gas turbine engine of claim 1, and further comprising:
the high pressure compressor includes a second compressor downstream from a first compressor;
the first compressor is an axial flow compressor with an inner compressed air flow path and an outer compressed air flow path;
the second compressor is an axial flow compressor downstream from the inner compressed air flow path; and,
the first compressor and second compressor are connected to a common rotor.

5. The industrial gas turbine engine of claim 1, and further comprising:
the air cooled airfoil is a row of turbine stator vanes.

6. The industrial gas turbine engine of claim 3, and further comprising:
the centrifugal compressor supplies the higher pressure compressed air to the air cooled airfoil; and,
the axial flow compressor of the second compressor supplies compressed air directly to the combustor.

7. The industrial gas turbine engine of claim 4, and further comprising:
the inner compressed air flow path supplies compressed air to the air cooled turbine airfoil; and,
the outer compressed air flow path supplies compressed air directly to the combustor.

8. A multiple stage compressor for an industrial gas turbine engine comprising:
a rotor;
a plurality of rows of rotor blades extending from the rotor;
a plurality of rows of stator vanes extending from a stationary housing of the multiple stage compressor;
the rows of rotor blades and rows of stator vanes each having a shroud to separate an inner compressed air flow path from an outer compressed air flow path; and,
the outer compressed air flow path makes up around 20% of the multiple stage compressor.

9. A multiple stage compressor for an industrial gas turbine engine of claim 8, and further comprising:
the inner flow path and the outer flow path are both axial flow paths.

10. A multiple stage compressor for an industrial gas turbine engine of claim 8, and further comprising:
a second compressor downstream from a first compressor;
the first compressor and the second compressor a connected to a common rotor; and,
the second compressor includes an axial flow inner compressed air flow path and a centrifugal flow outer compressed air flow path.

11. A multiple stage compressor for an industrial gas turbine engine comprising:
a rotor;
a plurality of rows of rotor blades extending from the rotor;
a plurality of rows of stator vanes extending from a stationary housing of the multiple stage compressor;
the rows of rotor blades and rows of stator vanes each having a shroud to separate an inner compressed air flow path from an outer compressed air flow path;
the rows of rotor blades and rows of stator vanes each having a shroud to separate an inner compressed air flow path from an outer compressed air flow path;
the inner compressed air flow path makes up around 20% of the multiple stage compressor;
a second compressor downstream from a first compressor;
the second compressor connected to the same rotor as the first compressor;
the second compressor includes multiple rows of rotor blades and stator vanes; and,
the second compressor forms a continuation of the inner compressed air flow path of the first compressor to further compress the air from the inner flow path.
